(19) United States
(12) Patent Application Publication
(10) Pub. No.: US 2008/0276865 A1
(43) Pub. Date: Nov. 13, 2008

(54) Electrostatic Chuck, Manufacturing method thereof and substrate treating apparatus

(75) Inventors: Ryoichi Nishimizu, Fukuoka-ken (JP); Hironori Hatono, Fukuoka-ken (JP); Akihiko Matsumura, Fukuoka-ken (JP)

Correspondence Address: CARRIER BLACKMAN AND ASSOCIATES, 24101 NOVI ROAD, SUITE 100, NOVI, MI, 48375, US

(73) Assignee: Toto Ltd., Kitakyusyu-shi (JP)

(21) Appl. No.: 11/998,459

(22) Filed: Nov. 29, 2007

(30) Foreign Application Priority Data
Nov. 29, 2006 (JP) 2006-321900
Nov. 27, 2007 (JP) 2007-306648

(51) Int. Cl. B05C 13/00; B05D 5/12

(52) U.S. Cl. 118/500; 427/58

(57) ABSTRACT

An electrostatic chuck includes: a mounting surface on which a workpiece is to be mounted, the mounting surface including a polycrystalline structure formed by aerosol deposition, the polycrystalline structure having a protrusion on its surface. At least the protrusion contains yttria (Y₂O₃).

### CROSS-REFERENCE TO RELATED APPLICATIONS

This application is based upon and claims the benefit of priorities from the prior Japanese Patent Application No. 2006-321900, filed on Nov. 29, 2006, and the prior Japanese Patent Application No. 2007-306648, filed on Nov. 27, 2007; the entire contents of which are incorporated herein by reference.

### BACKGROUND OF THE INVENTION

1. Field of the Invention

This invention relates to an electrostatic chuck, a method for manufacturing an electrostatic chuck, and a substrate processing apparatus.

2. Background Art

A substrate processing apparatus for performing etching, CVD (chemical vapor deposition), sputtering, ion implantation, ashing, exposure, and inspection includes an electrostatic chuck as a means for attracting and holding a workpiece such as a semiconductor substrate and a glass substrate.

A plasma processing apparatus is one type of this substrate processing apparatus. The plasma processing apparatus including an electrostatic chuck may damage the surface of the electrostatic chuck by plasma exposure, and adversely affect the quality of the workpiece due to particles resulting from plasma-induced erosion.

In this respect, a technique is proposed in which a layer structure of polycrystalline yttria having high plasma resistance is used for an electrostatic chuck (see JP-A 2005-217349 (Kokai)).

Here, the mounting surface on which a workpiece is mounted is covered with the workpiece, and hence is not exposed to plasma in the normal processing. Thus the technique disclosed in JP-A 2005-217349 (Kokai) has not been applied to such an area not exposed to plasma in the normal processing.

Furthermore, a technique is proposed in which sputtering is used to integrally form a member having a mounting surface from a material such as yttrium oxide (see JP-A 2005-093723 (Kokai)).

However, when sputtering is used to integrally form a member having a mounting surface from a material such as yttrium oxide, large-sized particles may drop off, causing particle contamination. Furthermore, difficulty in reducing the thickness results in poor heat transference, and the in-plane temperature uniformity of the workpiece may be deteriorated.

Moreover, forming recesses in the surface results in the occurrence of protrusions. However, no consideration has been given to the shape of the protrusion. Hence there may be particle contamination due to chipping of a corner portion of the protrusion periphery.

### SUMMARY OF THE INVENTION

According to an aspect of the invention, there is provided an electrostatic chuck including: a mounting surface on which a workpiece is to be mounted, the mounting surface including a polycrystalline structure formed by aerosol deposition, the polycrystalline structure having a protrusion on its surface, at least the protrusion containing yttria (Y₂O₃).

According to another aspect of the invention, there is provided an electrostatic chuck including: a polycrystalline structure on a major surface of a member including an electrode, the polycrystalline structure being formed by aerosol deposition, the polycrystalline structure having a protrusion on its surface, and at least the protrusion containing yttria (Y₂O₃).

According to another aspect of the invention, there is provided an electrostatic chuck including: a mounting surface on which a workpiece is to be mounted, the mounting surface including a polycrystalline structure made of a brittle material, the polycrystalline structure having a protrusion on its surface, at least the protrusion containing yttria (Y₂O₃), and substantially no grain boundary layer of a glass phase existing at a crystal-crystal interface.

According to another aspect of the invention, there is provided an electrostatic chuck including: a polycrystalline structure on a major surface of a member including an electrode, the polycrystalline structure being made of a brittle material, the polycrystalline structure having a protrusion on its surface, and at least the protrusion contains yttria (Y₂O₃), and substantially no grain boundary layer of a glass phase existing at a crystal-crystal interface.

According to another aspect of the invention, there is provided a method for manufacturing an electrostatic chuck, including: forming a polycrystalline structure by aerosol deposition on one major surface of a member including an electrode; and forming a protrusion by providing a mask having a desired configuration on a surface of the polycrystalline structure and removing a portion not covered with the mask by blasting.

According to another aspect of the invention, there is provided a substrate processing apparatus including: an electrostatic chuck including: a mounting surface on which a workpiece is to be mounted, the mounting surface including a polycrystalline structure formed by aerosol deposition, the polycrystalline structure having a protrusion on its surface, at least the protrusion containing yttria (Y₂O₃).

### BRIEF DESCRIPTION OF THE DRAWINGS

FIG. 1 is a schematic view for illustrating an electrostatic chuck according to a first embodiment of the invention.

FIG. 2 is a flow chart for illustrating the method for manufacturing an electrostatic chuck.

FIG. 3 is a flow chart for illustrating another example method for manufacturing an electrostatic chuck.

FIG. 4 is a schematic view for illustrating bonding a dielectric substrate to a base.

FIG. 5 is a schematic configurational view of a processing apparatus that can perform aerosol deposition.

FIG. 6 is a graph for illustrating the relationship between plasma exposure time and surface roughness.

FIG. 7 includes micrographs showing the surface condition of the polycrystalline yttria before and after plasma exposure, where FIGS. 7A and 7B are micrographs showing the surface condition before plasma exposure and after plasma exposure, respectively.

FIG. 8 includes micrographs showing the surface condition of the high-purity sintered alumina before and after plasma exposure, where FIGS. 8A and 8B are micrographs showing the surface condition before plasma exposure and after plasma exposure, respectively.

FIG. 9 includes micrographs showing the surface condition of the sintered yttria (HIP processed) before and after plasma exposure, where FIGS. 9A and 9B are micrographs showing the surface condition before plasma exposure and after plasma exposure, respectively.

FIG. 10 is a micrograph of a cross section of the alumina polycrystalline structure formed by aerosol deposition.

FIG. 11 is a schematic view for illustrating an electrostatic chuck according to a second embodiment of the invention.

FIG. 12 is a micrograph showing the surface condition of the semiconductor wafer (silicon wafer) after the reciprocal sliding test (sliding distance 5000 mm).

FIG. 13 is a graph showing the result of measuring the surface configuration of the sliding test sample after 500 reciprocations of sliding (sliding distance 5000 mm).

FIG. 14 is a schematic enlarged view for illustrating the vertical cross section of a protrusion according to a comparative example.

FIG. 15 is a schematic enlarged view for illustrating the vertical cross section of the protrusion according to this embodiment.

FIG. 16 is a micrograph of the protrusion according to this embodiment.

FIG. 17 is a micrograph of flaws formed by sliding between the flat surface and the workpiece.

FIG. 18 is a flow chart for illustrating the method for manufacturing the electrostatic chuck.

FIG. 19 is a flow chart for illustrating another example method for manufacturing the electrostatic chuck.

FIG. 20 is a schematic view for illustrating the configuration of an electrostatic chuck.

FIG. 21 is a schematic view for illustrating the configuration of an electrostatic chuck.

FIG. 22 is a schematic view for illustrating the configuration of an electrostatic chuck.

FIG. 23 is a schematic view for illustrating the configuration of an electrostatic chuck.

FIG. 24 is a schematic view for illustrating the configuration of an electrostatic chuck.

FIG. 25 is a schematic view for illustrating a substrate processing apparatus including the electrostatic chuck according to the embodiment of the invention.

### DETAILED DESCRIPTION OF THE INVENTION

Embodiments of the invention will now be described with reference to the drawings.

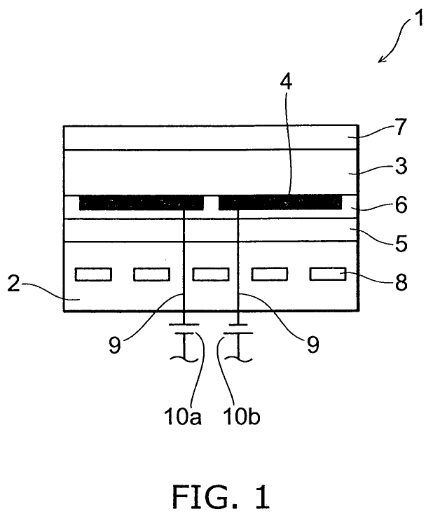

FIG. 1 is a schematic view for illustrating an electrostatic chuck according to a first embodiment of the invention.

As shown in FIG. 1, the electrostatic chuck 1 includes a base 2, a dielectric substrate 3, and electrodes 4.

An insulator film 5 made of an inorganic material is formed on one major surface (the surface on the electrode 4 side) of the base 2. A polycrystalline structure 7 made of a brittle material is formed by aerosol deposition on one major surface (on the mounting surface side) of the dielectric substrate 3, and the electrodes 4 are formed on the other major surface of the dielectric substrate 3.

That is, a polycrystalline structure 7 is formed by aerosol deposition on the major surface of a member (dielectric substrate 3) provided with the electrodes 4.

The upper surface of the polycrystalline structure 7 serves as a mounting surface of a workpiece such as a semiconductor wafer. The major surface with the electrodes 4 provided thereon and the major surface with the insulator film 5 provided thereon are bonded together with an insulative adhesive. The insulative adhesive, when cured, serves as a bonding layer 6.

The electrodes 4 are connected to a power supply 10a and a power supply 10b through wires 9. While the wires 9 are provided so as to run through the base 2, the wires 9 are insulated from the base 2. What is shown in FIG. 1 is known as a bipolar electrostatic chuck in which a positive and a negative electrode are adjacently formed on the dielectric substrate 3. However, the electrostatic chuck is not limited thereto, but it is also possible to use a monopolar electrostatic chuck in which a single electrode is formed on the dielectric substrate 3, or tripolar or other multipolar ones can be also used. The number of electrodes and their placement can be modified appropriately.

The base 2 can be composed of a metal having high thermal conductivity such as an aluminum alloy and copper, and can include a channel 8 through which cooling or heating liquid flows. The channel 8 is not necessarily needed, but preferably provided from the viewpoint of temperature control of the workpiece. The insulator film 5 formed on one major surface of the base 2 can be composed of polycrystals of alumina (Al₂O₃) or yttria (Y₂O₃), for example. However, in view of its use in a halogen gas plasma environment, it is preferable to use yttria, which has high resistance to halogen gas plasma. In this case, the content of yttria (Y₂O₃) is preferably 90 wt % or more in view of plasma resistance.

Preferably, substantially no grain boundary layer of a glassy material exists in the polycrystals. If substantially no grain boundary layer of a glassy material exists, erosion originating from a grain boundary layer does not proceed even on exposure to a plasma atmosphere, and particle dropping associated therewith can also be prevented or reduced. The film of such a structure can be formed by aerosol deposition, for example, which is described later.

The term “grain boundary layer” as used herein refers to a layer having a certain thickness (normally from nm to several μm) located at an interface, or a grain boundary as so called in a sintered body. The grain boundary layer normally assumes an amorphous structure different from the crystal structure in the crystal grain, and involves segregation of impurities in some cases.

The insulator film 5 preferably has a higher thermal conductivity than the bonding layer 6, and the thermal conductivity is preferably 2 W/mK or more. This is because the heat transference is more favorable than in the case of using the bonding layer alone, further improving the temperature controllability and in-plane temperature uniformity of the workpiece. Specifically, it is preferable to use polycrystals made of a brittle material such as alumina (Al₂O₃) or yttria (Y₂O₃) described above.

The insulator film 5 requires reliability of electrical insulation and heat transference. In order to achieve both of them, a dense thin film having high insulation withstand voltage is needed. Hence the insulator film 5 is preferably formed by aerosol deposition or thermal spraying. Specifically, in the case of thermal spraying, it is preferable to form a film of 300 μm or more and 600 μm or less in view of insulation withstand voltage. Examples of thermal spraying include flame spraying, atmospheric plasma spraying, low pressure plasma spraying, and arc spraying, but are not limited thereto. The description of these thermal spraying methods is omitted because known techniques are applicable thereto.

Here, if the insulator film 5 is formed by aerosol deposition, a denser and thinner film having higher insulation withstand voltage can be obtained, and hence the temperature controllability and in-plane temperature uniformity of the workpiece can be further improved. Specifically, if the insulator film 5 is formed by aerosol deposition, a very dense film can be obtained, and hence the volume resistivity of the film can be 10¹⁴ Ωcm or more. Therefore the thickness of the film can be made thinner than that formed by thermal spraying with an equal value of insulation withstand voltage, and hence heat transference can be further improved. Here, the film preferably measures 10 μm or more and 100 μm or less in view of reliability of electrical insulation and heat transference.

The bonding layer 6 is preferably selected to have high thermal conductivity. Specifically, the thermal conductivity is preferably 1 W/mK or more, and more preferably 1.6 W/mK or more. Such thermal conductivity can be obtained by adding alumina and/or aluminum nitride as a filler to a silicone resin, for example. The thermal conductivity can be also adjusted by the addition ratio.

The thickness of the bonding layer 6 is preferably made as small as possible in view of heat transference. On the other hand, the thickness of the bonding layer 6 is preferably made as large as possible considering that the bonding layer 6 may be peeled by thermal shear stress due to the difference in thermal expansion coefficient between the bonding layer 6 and the dielectric substrate 3. Hence, in view of these, the thickness of the bonding layer 6 is preferably 0.1 mm or more and 0.3 mm or less.

The dielectric substrate 3 can be made of diverse materials depending on various requirements for the electrostatic chuck. In view of thermal conductivity and reliability of electrical insulation, it is preferable to use a sintered ceramic. Examples of sintered ceramics include alumina, yttria, aluminum nitride, and silicon carbide. In view of its use in a halogen gas plasma environment, it is more preferable to use yttria, which has high resistance to halogen gas plasma. The content of yttria (Y₂O₃) is more preferably 90 wt % or more. A Coulomb type electrostatic chuck can be realized by setting the volume resistivity of the material of this dielectric substrate 3 to 10¹⁴ Ωcm or more in the operating temperature range, and a Johnsen-Rahbek type electrostatic chuck can be realized by setting it to 10⁸-10¹¹ Ωcm. The volume resistivity can be arbitrarily selected. However, for a volume resistivity of 10¹⁴ Ωcm, a strong Coulomb force occurs. In this case, even if any defect occurs in part of the polycrystalline structure 7 formed on the dielectric substrate 3 by aerosol deposition described later, it does not substantially interfere with suction characteristics.

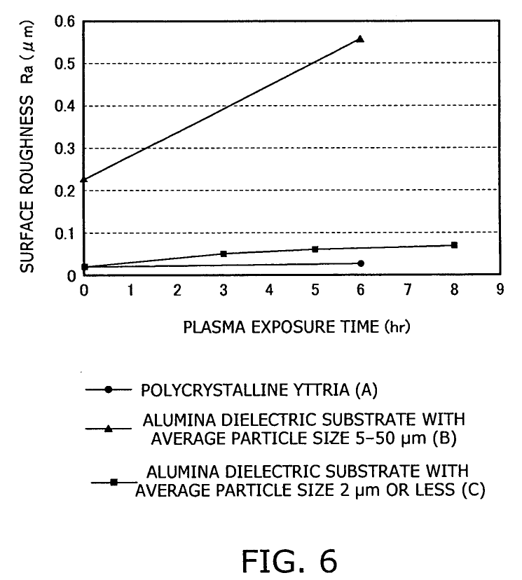

Furthermore, the dielectric substrate 3 is preferably made of a sintered ceramic having an average particle size of 2 μm or less. As described later with reference to FIG. 6, by using a sintered ceramic having an average particle size of 2 μm or less, the dielectric substrate 3 itself has high plasma resistance even if part of the polycrystalline structure 7 is eroded, and dropping of large-sized particles can also be prevented.

Here, film formation on a sintered ceramic (dielectric substrate 3) by aerosol deposition described later results in flat film formation irrespective of the presence of pores (open pores) in the sintered ceramic, which is characteristic of aerosol deposition. Hence pores (open pores), which possibly act as originating points of insulation breakdown, may remain at the interface between the film formed by aerosol deposition and the sintered ceramic.

As a result of investigations, the inventor has found that residual pores (open pores) can be reduced when one of the major surfaces of the dielectric substrate 3 on which the polycrystalline structure 7 is formed by aerosol deposition has a surface roughness Ra of 0.1 μm or less.

In the case of a Coulomb type electrostatic chuck, for use in a practical voltage range (±1000 V to ±5000 V, preferably ±2000 V to ±5000 V), the thickness of the dielectric substrate 3 is preferably 0.5 mm or less for ensuring sufficient suction force. Furthermore, in view of ease of manufacturing, the thickness of the dielectric substrate 3 is preferably 0.2 mm or more (more preferably, 0.3 mm or more).

In the case of a Johnsen-Rahbek type electrostatic chuck, for use in a practical voltage range (±500 V to ±2000 V), the thickness of the dielectric substrate 3 is preferably 1.5 mm or less. Furthermore, in view of ease of manufacturing, the thickness of the dielectric substrate 3 is preferably 0.2 mm or more (more preferably, 0.3 mm or more).

The total thickness of the dielectric substrate 3, the bonding layer 6, and the insulator film 5 is preferably 0.5 mm or more and 2.0 mm or less. An electrostatic chuck with such a thickness can ensure electrical insulation between the workpiece and the electrode and electrical insulation between the electrode and the base, and has good heat transference from the workpiece to the base. More preferably, the total thickness is set to 1.5 mm or less to reduce impedance between the workpiece made of a dielectric and the base.

Example materials of the electrode 4 include titanium oxide, elemental titanium, or a mixture of titanium and titanium oxide, titanium nitride, titanium carbide, tungsten, gold, silver, copper, aluminum, chromium, nickel, and gold-platinum.

Example materials of the polycrystalline structure 7 include polycrystalline materials such as alumina and yttria. Here, it is preferable to use yttria, which has high resistance to halogen gas plasma, and the content of yttria is preferably 90 wt % or more.

Preferably, substantially no grain boundary layer of a glassy material exists in the polycrystalline structure 7. If substantially no grain boundary layer of a glassy material exists, erosion originating from a grain boundary layer does not proceed even on exposure to a plasma atmosphere, and particle dropping associated therewith can be prevented or reduced. Furthermore, because surface irregularities may act as originating points of plasma-induced erosion, the surface roughness Ra is preferably 0.05 μm or less, and more preferably 0.03 μm or less. The film of such a structure can be formed by aerosol deposition, for example, which is described later.

Next, the operation of the electrostatic chuck according to this embodiment is described.

A workpiece (e.g., semiconductor wafer) is mounted on the upper surface of the polycrystalline structure 7 of the electrostatic chuck 1, and a voltage is applied to the electrodes 4 using the power supply 10a and the power supply 10b. Then, in the case of a Coulomb type electrostatic chuck, charges with different polarities occur on the workpiece and on the electrodes 4, and the workpiece is attracted and fixed by the Coulomb force acting between the charges. On the other hand, in the case of a Johnsen-Rahbek type electrostatic chuck, charges with different polarities occur on the workpiece and on the surface of the electrostatic chuck 1, and the workpiece is attracted and fixed by the Johnsen-Rahbek force acting between the charges.

In some processes for the workpiece, temperature control of the workpiece may be performed through the electrostatic chuck 1. In the electrostatic chuck 1 according to this embodiment, temperature control of the workpiece can be performed by passing cooling or heating liquid through the channel 8. Here, as described above, if the insulator film 5 and the polycrystalline structure 7 are formed by aerosol deposition, a dense and very thin film can be obtained, and hence the workpiece can be processed with the temperature controllability and in-plane temperature uniformity of the workpiece being further improved. For convenience of description, reference is made to the case where temperature control is performed by passing cooling or heating liquid. However, other temperature control means such as a heater may be provided. Also in this case, the insulator film 5 and the polycrystalline structure 7 can be formed as a dense and very thin film, and hence the workpiece can be processed with the temperature controllability and in-plane temperature uniformity of the workpiece being further improved.

Next, a method for manufacturing an electrostatic chuck according to this embodiment is described.

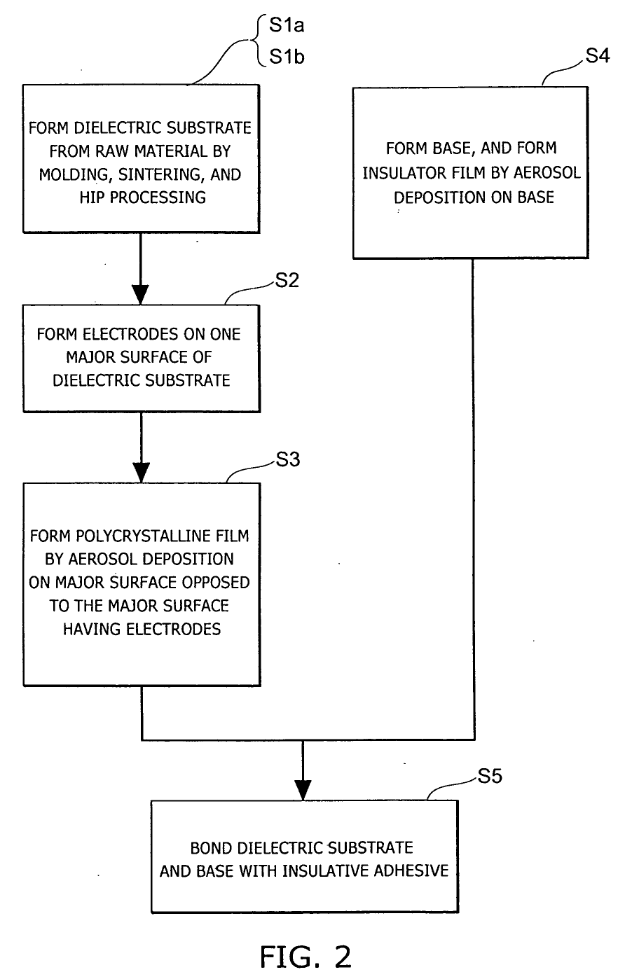

FIG. 2 is a flow chart for illustrating the method for manufacturing an electrostatic chuck.

First, a method for forming a dielectric substrate 3 is described.

In the case where the electrostatic chuck 1 is a Coulomb type electrostatic chuck, first, yttrium oxide (Y₂O₃) powder and boron oxide (B₂O₃) powder are used as raw materials. Boron oxide (B₂O₃) powder is added to yttrium oxide (Y₂O₃) powder in the proportion of 0.02 wt % or more and 10 wt % or less. This powder mixture is molded, and then sintered at 1300° C. or more and 1600° C. or less, and preferably at 1400° C. or more and 1500° C. or less.

Next, an HIP (hot isostatic pressing) process is performed in Ar gas at 1000 atm or more and at a temperature of 1200° C. or more and 1500° C. or less. Such condition results in an extremely dense dielectric substrate 3 having a relative density of 99% or more, where the volume resistivity is 10¹⁴ Ωcm or more at 20±3° C. (step S1a).

In the case where the electrostatic chuck 1 is a Johnsen-Rahbek type electrostatic chuck, first, alumina powder having an average particle size of 0.1 μm and a purity of 99.99% or more is used as a raw material, and ground with titanium oxide (TiO₂) in the proportion exceeding 0.2 wt % and being 0.6 wt % or less. An acrylic binder is added thereto, adjusted, and then granulated by a spray dryer to produce granulated powder.

Next, after CIP (rubber press) or mechanical press molding, the mold is processed into a predetermined shape, and sintered under a reducing atmosphere at 1150° C. to 1350° C. Then an HIP (hot isostatic pressing) process is performed in Ar gas at 1000 atm or more and at a temperature of 1150° C. to 1350° C., being the same as the sintering temperature. Such condition results in an extremely dense dielectric substrate 3 having a relative density of 99% or more, where the average particle size of the constituent particle is 2 μm or less, the volume resistivity is 10⁸-10¹¹ Ωcm or more at 20±3° C., and the thermal conductivity is 30 W/mK or more (step S1b).

The term “average particle size” as used herein refers to a particle size determined by the following planimetric method. First, a photograph of the dielectric substrate 3 is taken by a scanning electron microscope (SEM). A circle having a known area A is drawn on the photograph. The number of particles per unit area, NG, is determined by the following formula (1) from the number of particles in the circle, nc, and the number of particles intersecting the perimeter of the circle, ni:

$$NG = \frac{nc + \frac{1}{2} ni}{\frac{A}{{m}^{2}}} \qquad ( 1 )$$

where m is the magnification of the photograph. Because 1/NG is the area occupied by one particle, the average particle size can be determined by the following formula (2), which represents the circle-equivalent diameter:

$$\frac{2}{\sqrt{π \cdot NG}} \qquad ( 2 )$$

Next, one major surface of the dielectric substrate 3 is ground, and then a conductive film of titanium carbide or titanium described above is formed thereon by CVD (chemical vapor deposition) or PVD (physical vapor deposition). The formed film is shaped into a predetermined configuration by sand blasting or etching to form electrodes 4 having a desired configuration (step S2). Here, wires 9 are connected to the electrodes 4 as appropriate.

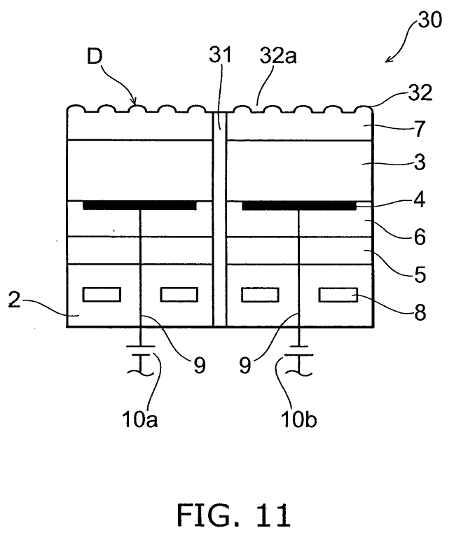

Next, a polycrystalline structure 7 is formed by aerosol deposition on the other major surface of the dielectric substrate 3, which is opposed to the major surface with the electrodes provided thereon (step S3). It is noted that protrusions 32 described later with reference to FIG. 11 may be further formed.

On the other hand, a base 2 including a channel 8 is fabricated by cutting, and an insulator film 5 is formed by aerosol deposition on one major surface of the base 2 (step S4). It is noted that, alternatively, the insulator film 5 can be formed by aerosol deposition on the entire surface of the base 2.

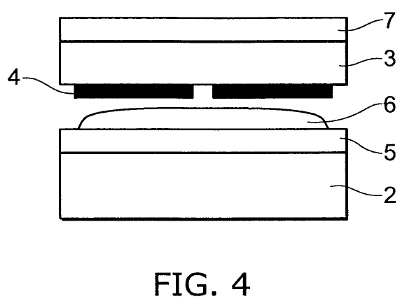

Next, as shown in FIG. 4, the major surface of the dielectric substrate 3 with the electrodes 4 provided thereon and the major surface of the base 2 with the insulator film 5 provided thereon are bonded together with an insulative adhesive (step S5). Here, the wires 9 are passed to run through the base 2 so that the electrodes 4 can be connected to the power supply 10a and the power supply 10b by the wires 9. The insulative adhesive, when cured, serves as a bonding layer 6.

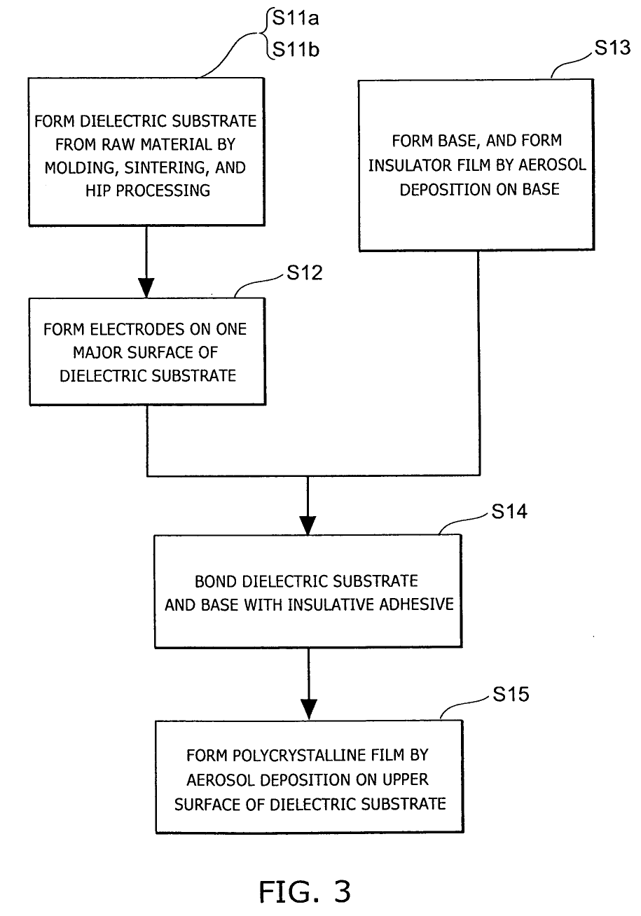

FIG. 3 is a flow chart for illustrating another example method for manufacturing an electrostatic chuck.

This method is different from that described with reference to FIG. 2 in the procedure of forming the polycrystalline structure 7. That is, after the base 2 and the dielectric substrate 3 are bonded together, a polycrystalline structure 7 is formed by aerosol deposition on the upper surface of the dielectric substrate 3 (the major surface opposed to the major surface with the electrodes provided thereon).

Specifically, as in step S1a, S1b of FIG. 2, a dielectric substrate 3 is formed from raw material by molding, sintering, and HIP processing (step S11a, S11b). As in step S2 of FIG. 2, electrodes are formed on one major surface of the dielectric substrate 3 (step S12). Here, step S11a corresponds to the case of a Coulomb type electrostatic chuck, and step S11b corresponds to the case of a Johnsen-Rahbek type electrostatic chuck.

On the other hand, as in step S4 of FIG. 2, a base 2 is formed, and an insulator film 5 is formed by aerosol deposition on the base 2 (step S13).

Then, as in step S5 of FIG. 2, the major surface of the dielectric substrate 3 with the electrodes 4 provided thereon and the major surface of the base 2 with the insulator film 5 provided thereon are bonded together with an insulative adhesive (step S14).

Next, the major surface of the dielectric substrate 3 opposed to the major surface with the electrodes 4 provided thereon is ground/polished, and a polycrystalline structure 7 is formed thereon by aerosol deposition (step S15).

Here, the surface roughness Ra (center-line average roughness) is preferably set to 0.1 μm or less by grinding/polishing.

In film formation by aerosol deposition, a residual stress occurs in the formed film. Hence deformation may occur if the matrix used for film formation has a low stiffness. In this embodiment, after the base 2 and the dielectric substrate 3 are bonded together, a polycrystalline structure 7 is formed by aerosol deposition on the upper surface of the dielectric substrate 3 (the major surface opposed to the major surface with the electrodes provided thereon). Thus the stiffness of the matrix (bonded body of the base 2 and the dielectric substrate 3) used for film formation can be increased, and hence deformation due to the residual stress can be prevented. Consequently, the flatness of the upper surface (mounting surface) of the polycrystalline structure 7 can be further increased, and adhesion to the workpiece can be further improved. Furthermore, the accuracy of circuit formation on the workpiece such as a semiconductor wafer can be improved.

It is noted that protrusions 32 described later with reference to FIG. 11 may be further formed. The rest of the procedure and content is the same as that described with reference to FIG. 2, and hence the description thereof is omitted.

Here, formation of the polycrystalline structure 7 and the insulator film 5 by aerosol deposition is described.

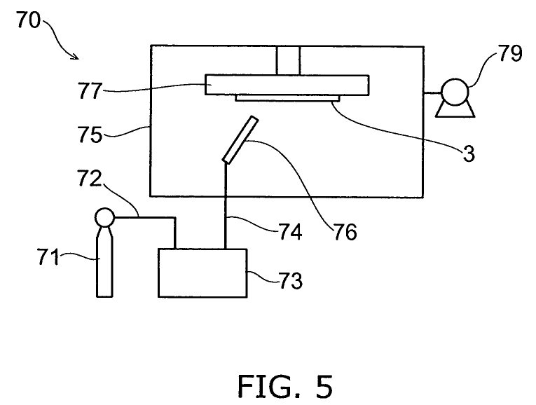

FIG. 5 is a schematic configurational view of a processing apparatus that can perform aerosol deposition.

As shown in FIG. 5, the processing apparatus 70 has a formation chamber 75. A nozzle 76 and an X-Y stage 77 are provided inside the formation chamber 75 so that an aerosol sprayed from the nozzle 76 is applied to a surface to be processed of the dielectric substrate 3 or the base 2 mounted and held on the X-Y stage 77. One end of an aerosol transport tube 74 is connected to one end (supply port) of the nozzle 76, and the other end of aerosol transport tube 74 is connected to an aerosol generator 73. The aerosol generator 73 is connected to a gas cylinder 71 through a gas piping 72. Furthermore, a vacuum pump 79 is connected to the formation chamber 75. The opening dimensions of the nozzle 76 can be, for example, approximately 0.4 to 1 mm long and approximately 10 to 20 mm wide. Source fine particles (e.g., fine ceramic particles) stored in the aerosol generator 73 can have an average particle size of approximately 0.1 to 5 μm.

Next, a process (aerosol deposition) based on the processing apparatus 70 is described.

First, the vacuum pump 79 is operated so that the inside of the formation chamber 75 is set to, and maintained at, approximately several Pa to several kPa.

Next, the gas cylinder 71 is opened to introduce nitrogen gas or helium gas at a flow rate of approximately 3 to 20 L/min into the aerosol generator 73 through the gas piping 72. An aerosol is generated from the introduced nitrogen gas or helium gas and source fine particles (e.g., fine yttria particles) stored beforehand.

The generated aerosol is carried through the aerosol transport tube 74 to the nozzle 76, and sprayed at a high speed from the opening of the nozzle 76 toward the surface to be processed of the dielectric substrate 3 or the base 2. At this time, source fine particles (e.g., fine yttria particles) impinge on the surface to be processed of the dielectric substrate 3 or the base 2, fracturing into fine fragment particles. Then they are instantaneously recombined into a bonded body of fine crystallites, forming a polycrystalline structure 7 or an insulator film 5 on the surface to be processed of the dielectric substrate 3 or the base 2.

The polycrystalline structure 7 or the insulator film 5 thus formed has an average crystallite size that is extremely smaller than that of the source fine particle, and the size can be even approximately 5 nm. Here the particle size typically problematic in particle contamination is approximately 0.3 μm. Hence, even if any crystallites drop off, they do not affect the quality of precision electronic components such as semiconductor devices and liquid crystal display devices. It is noted that the average crystallite size can be selected in accordance with the degree of downscaling of the precision electronic component such as a semiconductor device or a liquid crystal display device. For example, the average crystallite size can be less than 70 nm for an interconnect width of the semiconductor device of 90 nm by design rule, the average crystallite size can be less than 50 nm for an interconnect width of 65 nm by design rule, the average crystallite size can be less than 30 nm for an interconnect width of 45 nm by design rule, and the average crystallite size can be less than 20 nm for an interconnect width of 32 nm by design rule.

Furthermore, it is often the case that the crystal has substantially no crystal orientation, and substantially no grain boundary layer of a glass phase exists at the crystal-crystal interface of the brittle material. Hence erosion originating from a grain boundary layer does not proceed even on exposure to a plasma atmosphere, and particle dropping associated therewith can also be prevented or reduced.

Furthermore, as described later with reference to FIG. 6, by using a sintered ceramic having an average particle size of 2 μm or less for the dielectric substrate 3, the dielectric substrate 3 itself has high plasma resistance even if part of the polycrystalline structure 7 is eroded by long-term exposure to plasma, and dropping of large-sized particles can also be prevented. Therefore particle contamination can be reduced, and stable plasma resistance and suction/detachment characteristics for the electrostatic chuck can be maintained.

Furthermore, part of the polycrystalline structure 7 or the insulator film 5 serves as an anchor portion biting into the matrix surface. Hence a robust film resistant to peeling can be obtained.

Furthermore, if the polycrystalline structure 7 or the insulator film 5 is formed from fine yttria particles, resistance to a halogen gas plasma can be significantly improved in combination with the above effects.

Furthermore, the film thus formed is dense, and reliability of electrical insulation and plasma resistance are not compromised even if the film is extremely thinned. Hence, because the insulator film 5 can be extremely thinned, heat transference increases, and the temperature controllability and in-plane temperature uniformity of the workpiece can be significantly improved.

Next, measurement of the average crystallite size of the film formed by aerosol deposition is described.

The above processing apparatus 70 was used to prepare polycrystalline yttria and polycrystalline alumina samples. Specifically, by setting the average particle size of the fine yttria particle to 0.4 μm and introducing high-purity nitrogen gas as a carrier gas at a flow rate of 7 L/min, an yttria film (layer structure) of polycrystalline yttria having a formation height of 40 μm and a formation area of 20 mm×20 mm was formed on an aluminum substrate. Likewise, by setting the average particle size of the fine alumina particle to 0.2 μm and introducing high-purity nitrogen gas as a carrier gas at a flow rate of 7 L/min, an alumina film (layer structure) of polycrystalline alumina having a formation height of 40 μm and a formation area of 20 mm×20 mm was formed on an aluminum substrate.

The average crystallite size of the yttria film and the alumina film thus formed was measured and calculated by the Scherrer method using an X-ray diffractometer (MXP-18, XPRESS, manufactured by MAC Science).

The result is shown in TABLE 1. As seen from TABLE 1, the average crystallite size of the yttria film and the alumina film formed by aerosol deposition was 19.2 nm and 16.0 nm, respectively, and it was confirmed that the film is composed of very small crystals.

TABLE 1

| Sample | Yttria film | Alumina film |
|---|---|---|
| Average crystallite size (nm) | 19.2 | 16.0 |

Next, evaluation of plasma resistance of the film formed by aerosol deposition is described.

The above processing apparatus 70 was used to prepare a polycrystalline yttria sample. Specifically, by setting the average particle size of the fine yttria particle to 0.4 μm and introducing high-purity nitrogen gas as a carrier gas at a flow rate of 7 L/min, an yttria film (layer structure) of polycrystalline yttria having a formation height of 5 μm and a formation area of 20 mm×20 mm was formed on a quartz substrate.

For evaluation of plasma resistance, the following samples were prepared: (A) polycrystalline yttria formed on a quartz substrate, (B) an alumina dielectric substrate having an average particle size of 5 to 50 μm, and (C) an alumina dielectric substrate having an average particle size of 2 μm or less. The samples were exposed to a plasma atmosphere in an RIE etcher (DEA-506, manufactured by NEC ANELVA Corp.), using CF₄ and O₂ as a reaction gas (at a mixing ratio of CF₄ (40 sccm)+O₂ (10 sccm)) and setting the degree of vacuum to 3-8 Pa, the microwave power to 1 kW (0.55 W/cm²), the frequency to 13.56 MHz, and the exposure time to 3, 5, 6, and 8 hours.

After the samples were exposed to the plasma atmosphere, the surface roughness (Ra) of the sample surface was evaluated using a surface roughness/configuration measuring instrument (SURFCOM 130A, manufactured by Tokyo Seimitsu Co., Ltd.). The result is shown in FIG. 6.

Here, the evaluation was made in conformity with the JIS standard (JIS B0601:2001).

FIG. 6 is a graph for illustrating the relationship between plasma exposure time and surface roughness.

As seen from FIG. 6, the surface roughness of the alumina dielectric substrate having an average particle size of 5 to 50 μm (B) was 0.2 μm before plasma exposure, but was 0.55 μm after 5 hours of plasma exposure, showing deterioration by a factor of approximately 2.5. It is noted that an alumina dielectric substrate having an average particle size of 5 to 50 μm is commonly used as a member of an electrostatic chuck included in a plasma processing apparatus.

The surface roughness of the alumina dielectric substrate having an average particle size of 2 μm or less (C) was 0.02 μm before plasma exposure, indicating a good surface condition, but was 0.06 μm after 5 hours of exposure, showing deterioration by a factor of approximately 3. However, it has higher plasma resistance and smaller particle size than those of the commonly-used alumina dielectric substrate having an average particle size of 5 to 50 μm (B), and hence dropping of large-sized particles can be prevented. Therefore particle contamination can be reduced, and stable plasma resistance and suction/detachment characteristics can be maintained.

However, the surface roughness of the polycrystalline yttria film (A), which was formed by aerosol deposition, scarcely changed even after 6 hours of plasma exposure, from 0.02 to 0.027 μm. Thus its higher resistance to a halogen gas plasma was confirmed. Furthermore, as described above, because the particle size is extremely small, there is no problem of particle contamination even if particle dropping occurs.

Next, as an evaluation of plasma resistance, the surface condition before and after plasma exposure was observed.

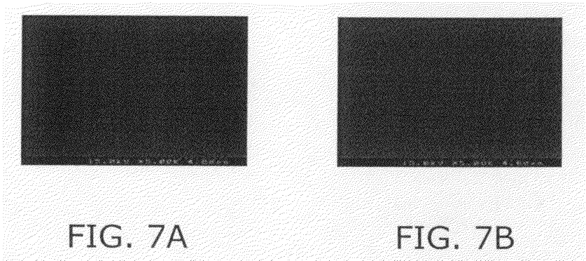

The samples used were the polycrystalline yttria formed on a quartz substrate described above (A), a high-purity sintered alumina, and a sintered yttria (HIP processed). These samples were simultaneously exposed to a halogen gas plasma environment, and the surface condition before and after the plasma exposure was observed by a scanning electron microscope (S-4100, manufactured by Hitachi). The observation results are shown in FIGS. 7 to 9.

FIG. 7 includes micrographs showing the surface condition of the polycrystalline yttria (A) before and after plasma exposure, where FIGS. 7A and 7B are micrographs showing the surface condition before plasma exposure and after plasma exposure, respectively.

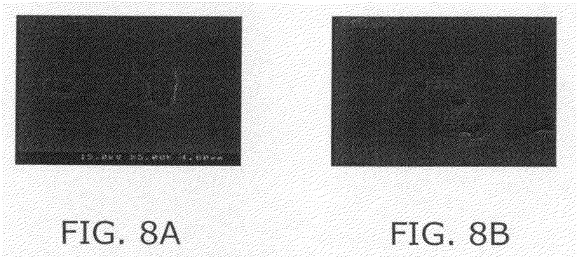

FIG. 8 includes micrographs showing the surface condition of the high-purity sintered alumina before and after plasma exposure, where FIGS. 8A and 8B are micrographs showing the surface condition before plasma exposure and after plasma exposure, respectively.

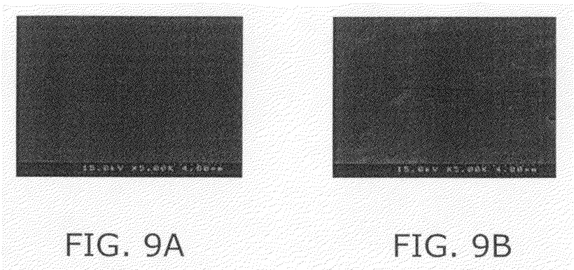

FIG. 9 includes micrographs showing the surface condition of the sintered yttria (HIP processed) before and after plasma exposure, where FIGS. 9A and 9B are micrographs showing the surface condition before plasma exposure and after plasma exposure, respectively.

Before plasma exposure, as seen from FIGS. 7A, 8A, and 9A, pores several μm in size are observed on the surface of the high-purity sintered alumina and the sintered yttria (HIP processed), but such pores are not observed on the surface of the polycrystalline yttria formed by aerosol deposition (A). This indicates that the film formed by aerosol deposition has a smooth surface, and also means that this smoothness contributes to preventing/reducing erosion due to plasma exposure and particle dropping. The observation also demonstrates that the formed film is dense.

After plasma exposure, as seen from FIGS. 7B, 8B, and 9B, pores larger in size and number than those before plasma exposure are observed on the surface of the high-purity sintered alumina and the sintered yttria (HIP processed). This means that the plasma exposure causes erosion and particle dropping of the surface. In contrast, the surface of the polycrystalline yttria formed by aerosol deposition (A) remains almost unchanged even after plasma exposure, and no pores are observed.

Next, the crystal structure of the film formed by aerosol deposition was observed.

First, the above processing apparatus 70 was used to prepare a polycrystalline alumina sample. Specifically, by setting the average particle size of the fine alumina particle to 0.2 μm and introducing high-purity nitrogen gas as a carrier gas at a flow rate of 7 L/min, an alumina film (layer structure) of polycrystalline alumina having a formation height of 40 μm and a formation area of 20 mm×20 mm was formed on an aluminum substrate.

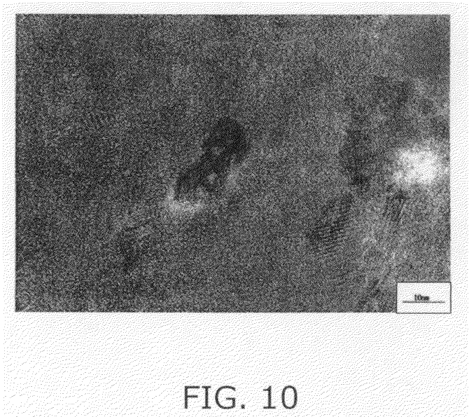

Next, the crystal structure of a cross section of the sample film was observed by a transmission electron microscope (H-9000UHR, manufactured by Hitachi). The observation result is shown in FIG. 10.

FIG. 10 is a micrograph of a cross section of the alumina polycrystalline structure formed by aerosol deposition.

As seen from FIG. 10, it was confirmed that the polycrystalline alumina formed by aerosol deposition includes substantially no grain boundary layer of a glass phase at the crystal-crystal interface, and has a structure composed of crystallites several nm to several ten nm in size. Here, for convenience of description, reference is made to polycrystalline alumina, but the same also applies to other films (e.g., polycrystalline yttria) formed by aerosol deposition.

As described above, when substantially no grain boundary layer of a glass phase exists at the crystal-crystal interface, erosion originating from a grain boundary layer does not proceed even on exposure to a plasma atmosphere, and particle dropping associated therewith can also be prevented or reduced.

FIG. 11 is a schematic view for illustrating an electrostatic chuck according to a second embodiment of the invention.

The same elements as those described with reference to FIG. 1 are marked with like reference numerals, and the description thereof is omitted.

As shown in FIG. 11, the electrostatic chuck 30 includes a dielectric substrate 3. A polycrystalline structure 7 made of a brittle material is formed by aerosol deposition on one major surface (on the mounting surface side) of the dielectric substrate 3. Furthermore, protrusions 32 are formed on the surface (on the mounting surface side) of the polycrystalline structure 7. The upper surface of the protrusions 32 serves as a mounting surface of a workpiece such as a semiconductor wafer.

The material and shape of the protrusion 32 are described later.

A through hole 31 is provided to run through the center of the electrostatic chuck 30. One end of the through hole 31 opens to the upper surface of the polycrystalline structure 7, and the other end is connected through a pressure regulating means and a flow regulating means, not shown, to a gas supply means, also not shown. The gas supply means, not shown, serves to supply helium gas or argon gas, and recesses 32a formed by the protrusions 32 constitute a channel for the supplied gas. The recesses 32a communicate with each other so that the supplied gas is distributed entirely.

The gas (e.g., helium gas) supplied from the gas supply means, not shown, is regulated in pressure and flow rate by the pressure regulating means and the flow regulating means, not shown, and then introduced into the recesses 32a through the through hole 31. The introduced gas passes through the recesses 32a and is distributed throughout the upper surface of the polycrystalline structure 7. The introduced gas is also guided to between the protrusions 32 and the workpiece and significantly enhances thermal conductivity therebetween. Thus the temperature of the base 2 can be effectively transferred to the workpiece.

As described above, in the electrostatic chuck 30 according to this embodiment, the insulator film 5 and the polycrystalline structure 7 are extremely thin. Therefore heat transference further increases, and the temperature controllability and in-plane temperature uniformity of the workpiece can be significantly improved.

Here, when a workpiece such as a semiconductor wafer is mounted on the upper surface of the protrusions 32, temperature variation may cause a difference in the amount of thermal expansion between the workpiece (e.g., semiconductor wafer) and the member of the electrostatic chuck 30 adjacent to the mounting surface. If any difference occurs therebetween in the amount of thermal expansion, sliding occurs between the upper surface (mounting surface) of the protrusions 32 and the rear surface of the workpiece.

Furthermore, microscopic bending occurs in a portion of the workpiece located between the protrusions 32, or above the recess 32a. Here, it is considered that the so-called “spatial Coulomb force” acts in the recess 32a, and hence the workpiece tends to bend downward by the electrostatic suction force. On the other hand, when a gas is introduced into the recess 32a, the workpiece tends to bend upward by the pressure difference from the internal pressure of the processing chamber 101 described later.

Hence, if the balance between these forces fluctuates, the workpiece also vertically repeats microscopic bending, causing sliding between the upper surface (mounting surface) of the protrusions 32 and the rear surface of the workpiece.

In this case, if the protrusion 32 is composed of a material having poor plasma resistance, the surface roughness of the upper surface (mounting surface) of the protrusions 32 gradually increases, and the surface of the workpiece (e.g., semiconductor wafer) may be damaged upon sliding. Furthermore, sliding may cause particle contamination.

Moreover, if the protrusions 32 are formed, the pressure receiving area decreases, which may increase flaws on the workpiece and particle contamination.

Here, the material of the protrusion 32 is described.

If the protrusion 32 is composed of polycrystalline yttria (Y₂O₃), plasma resistance can be significantly improved as described above. Hence degradation of the surface roughness of the upper surface (mounting surface) of the protrusion 32 can be prevented. Thus flaws occurring on the surface of the workpiece and particle contamination can be significantly reduced. In this case, the content of yttria (Y₂O₃) is preferably 90 wt % or more in view of plasma resistance.

Furthermore, as described above, it is preferable in view of plasma resistance that substantially no grain boundary layer of a glass phase exist at the crystal-crystal interface. This can be achieved, for example, by performing film formation by aerosol deposition.

Furthermore, according to the knowledge obtained by the inventor, the hardness of yttria (Y₂O₃) is comparable to or slightly lower than that of silicon (Si) constituting a semiconductor wafer (silicon wafer), which is a typical workpiece, and occurrence of flaws on the surface of the semiconductor wafer can be prevented even if sliding occurs. Moreover, because the occurrence of flaws is prevented, particle contamination is also prevented. The effect of preventing the occurrence of flaws and particle contamination in polycrystalline yttria (Y₂O₃) is described later.

It is considered that the influence associated with the occurrence of sliding increases as the pressure receiving area decreases. Hence, if the protrusion 32 is formed from polycrystalline yttria (Y₂O₃), a significant effect can be achieved for preventing the occurrence of flaws and preventing particle contamination.

Next, the effect of preventing the occurrence of flaws and particle contamination in polycrystalline yttria (Y₂O₃) is described.

Here, a reciprocal sliding test was performed, and the result was used to evaluate the occurrence of flaws and the occurrence of particle contamination.

First, a description is given of the occurrence of flaws and particle contamination in alumina (Al₂O₃), which is a comparative example investigated by the inventor.

The sliding test sample was an alumina (Al₂O₃) plate having planar dimensions of 20 mm×20 mm and a thickness of 2 mm, the surface (test surface) of which was lapped.

Here, the surface roughness of the sliding test sample was 0.02 μm in terms of Ra (center-line average roughness) and 0.2 μm in terms of Rz (ten-point average height roughness), and the flatness was 0.2 μm or less. The hardness of the sliding test sample was 1981 Hv in Vickers hardness.

The initial surface roughness of a semiconductor wafer (silicon wafer) surface to be brought into contact was 0.03 μm in terms of Ra (center-line average roughness) and 0.23 μm in terms of Rz (ten-point average height roughness), and hardness of the semiconductor wafer (silicon wafer) was 1042 Hv in Vickers hardness.

The sliding test apparatus used was the Washability Tester manufactured by Tester Sangyo Co., Ltd. The surface roughness/configuration measuring apparatus used was SURFCOM 130A manufactured by Tokyo Seimitsu Co., Ltd.

The reciprocal sliding test was performed by the following procedure.

First, the sliding test sample (alumina (Al₂O₃) plate) was fixed onto the test stage of the above sliding test apparatus, and the semiconductor wafer (silicon wafer) was stacked on the sliding test sample. Then the reciprocal sliding test was performed by reciprocating the semiconductor wafer (silicon wafer) while applying a load thereon using a weight.

Here, the contact pressure was 0.048 kgf/cm², and the sliding distance was 1000 mm (100 reciprocations) and 5000 mm (500 reciprocations). The sliding speed was 60 reciprocations/min.

Observation was made on the surface of the semiconductor wafer (silicon wafer) and the sliding test sample after the reciprocal sliding test thus performed. Then scraped portions were observed on the semiconductor wafer (silicon wafer) surface for both 100 reciprocations of sliding (sliding distance 1000 mm) and 500 reciprocations of sliding (sliding distance 5000 mm). Furthermore, roughened portions were observed on the entire surface of the slid portion of the sliding test sample (alumina (Al₂O₃) plate).

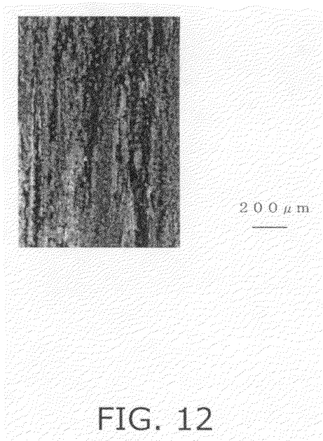

FIG. 12 is a micrograph showing the surface condition of the semiconductor wafer (silicon wafer) after the reciprocal sliding test (sliding distance 5000 mm).

As seen from FIG. 12, scraped portions are observed on the semiconductor wafer (silicon wafer) surface.

Furthermore, measurement was made on the surface configuration of the sliding test sample (alumina (Al₂O₃) plate) after 500 reciprocation of sliding (sliding distance 5000 mm), as viewed across the sliding surface with respect to the semiconductor wafer (silicon wafer). Then embossments approximately several hundred nm in size were observed in the slid portion. From this observation, the roughened portion on the surface of the sliding test sample (alumina (Al₂O₃) plate) can be identified as scraped debris of the semiconductor wafer (silicon wafer) attached thereto.

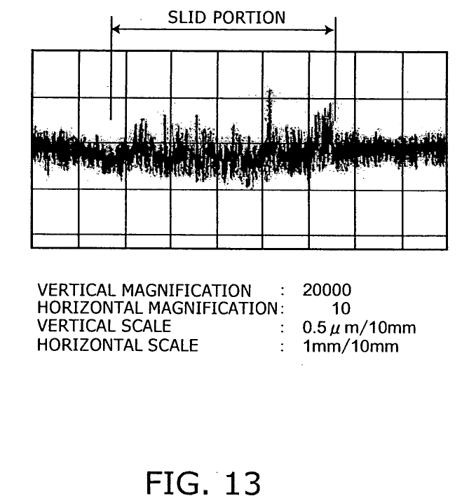

FIG. 13 is a graph showing the result of measuring the surface configuration of the sliding test sample after 500 reciprocations of sliding (sliding distance 5000 mm).

As seen from FIG. 13, embossments approximately several hundred nm in size are observed in the slid portion of the sliding test sample.

Thus, if alumina (Al₂O₃), which is commonly used in an electrostatic chuck, is used for the protrusion 32, flaws may occur on the surface of the semiconductor wafer (silicon wafer), and silicon (Si) detached (scraped) from the semiconductor wafer (silicon wafer) may cause particle contamination.

In this case, in the protrusion 32, the pressure receiving area is smaller than in the case of the above reciprocal sliding test. Hence the occurrence of flaws and the occurrence of particle contamination may be even increased.

Next, the effect of preventing the occurrence of flaws and particle contamination in yttria (Y₂O₃) polycrystalline structure is described.

The sliding test sample was a quartz substrate having planar dimensions of 10 mm×20 mm and a thickness of approximately 5 mm. The above processing apparatus 70 was used to form thereon an yttria (Y₂O₃) polycrystalline structure (by aerosol deposition), the surface (test surface) of which was lapped.

Here, the film thickness of the yttria (Y₂O₃) polycrystalline structure was approximately 2 to 3 μm, the surface roughness of the film surface was 0.02 μm in terms of Ra (center-line average roughness) and 0.09 μm in terms of Rz (ten-point average height roughness), and the flatness was 0.2 μm or less. The hardness of the yttria (Y₂O₃) polycrystalline structure was 765 Hv in Vickers hardness.

The initial surface roughness of a semiconductor wafer (silicon wafer) surface to be brought into contact was 0.03 μm in terms of Ra (center-line average roughness) and 0.23 μm in terms of Rz (ten-point average height roughness), and hardness of the semiconductor wafer (silicon wafer) was 1042 Hv in Vickers hardness.

The sliding test apparatus, the surface roughness/configuration measuring apparatus, the procedure of the reciprocal sliding test, and the test conditions (contact pressure, sliding distance, sliding speed, etc.) were the same as those for alumina (Al₂O₃) described above.

Observation was made on the semiconductor wafer (silicon wafer) after the reciprocal sliding test thus performed. However, no occurrence of flaws on the surface of the semiconductor wafer (silicon wafer) was confirmed for both 100 reciprocations of sliding (sliding distance 1000 mm) and 500 reciprocations of sliding (sliding distance 5000 mm).

Thus, if the yttria (Y₂O₃) polycrystalline structure is used for the protrusion 32, the occurrence of flaws on the surface of the semiconductor wafer (silicon wafer) can be prevented. Furthermore, silicon (Si) is not detached from the semiconductor wafer (silicon wafer), and hence the occurrence of particle contamination can be also prevented. It is considered that this is because the hardness of yttria (Y₂O₃) is lower than silicon (Si).

Furthermore, because the yttria (Y₂O₃) polycrystalline structure according to this embodiment is formed by aerosol deposition, the average crystallite size is extremely small as described above. Hence there is no danger of the occurrence of particle contamination even if any crystallites are detached.

Furthermore, the pressure receiving area is smaller in the protrusions 32. Hence, if the yttria (Y₂O₃) polycrystalline structure is formed in such portions by aerosol deposition, a significant effect can be achieved for preventing the occurrence of flaws and preventing particle contamination.

Next, the shape of the protrusion 32 is described.

The horizontal cross section of the protrusion 32 can be an arbitrary shape. However, cornerless shapes such as a circle can prevent cracking and chipping.

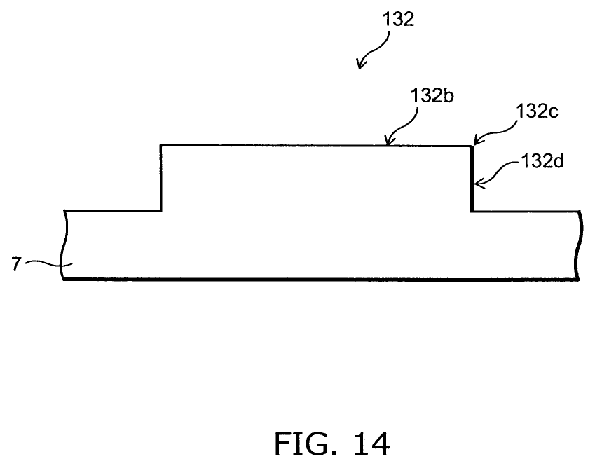

FIG. 14 is a schematic enlarged view for illustrating the vertical cross section of a protrusion 132 according to a comparative example.

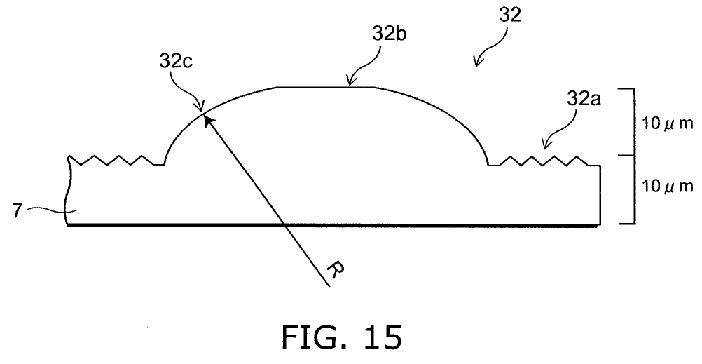

FIG. 15 is a schematic enlarged view for illustrating the vertical cross section of the protrusion 32 according to this embodiment. It is noted that FIG. 15 is an enlarged view of the portion D in FIG. 11.

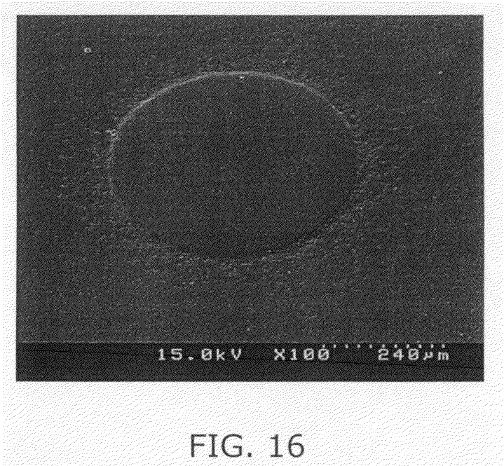

FIG. 16 is a micrograph of the protrusion 32 according to this embodiment. More specifically, FIG. 16 is a micrograph for illustrating the protrusion 32 having a diameter of 500 μm in design dimension.

First, the protrusion 132 according to the comparative example is described.

As shown in FIG. 14, the protrusion 132 has a flat surface 132b on top, which is directly connected to its side face 132d. Hence there is a corner 132c at the periphery of the flat surface 132b.

A workpiece such as a semiconductor wafer is to be mounted on the flat surface 132b. That is, the flat surface 132b serves as a mounting surface.

Here, as described above, the difference in the amount of thermal expansion between the workpiece (e.g., semiconductor wafer) and the member of the electrostatic chuck 30 adjacent to the mounting surface causes sliding between the flat surface 132b and the rear surface of the workpiece. Furthermore, if there is any fluctuation in the force balance of the “spatial Coulomb force” versus the pressure difference between the pressure in the recess and the internal pressure of the processing chamber 101 described later, then the workpiece vertically repeats microscopic bending, causing sliding between the flat surface 132b and the rear surface of the workpiece.

Sliding between the flat surface 132b and the workpiece may cause flaws on the workpiece.

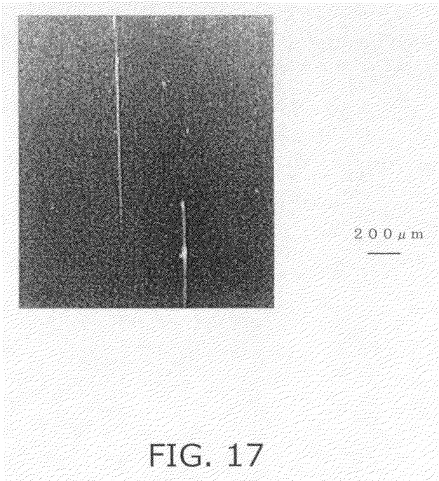

FIG. 17 is a micrograph of flaws formed by sliding between the flat surface 132b and the workpiece. More specifically, FIG. 17 is a micrograph of flaws formed in the following reciprocal sliding test.

In the reciprocal sliding test, the above processing apparatus 70 was used to form an yttria (Y₂O₃) polycrystalline structure (by aerosol deposition) on a quartz substrate having planar dimensions of 10 mm×20 mm and a thickness of approximately 5 mm. Subsequently, a photoresist film punctured with a protrusion pattern was applied to the surface thereof, only the protrusion 132 was formed by aerosol deposition using yttria as raw material, and then the film was removed. Specifically, a cylindrical protrusion 132 having a diameter of approximately 2000 μm was formed. Then, by lapping, a flat surface 132b with its peripheral edge having a corner (a square corner being illustrated in FIG. 14) was formed. This was used as a sliding test sample.

The sliding test apparatus, the procedure of the reciprocal sliding test, and the test conditions (contact pressure, sliding distance, sliding speed, etc.) were the same as those for the reciprocal sliding test described above. The workpiece was a semiconductor wafer (silicon wafer).

As described above, because yttria (Y₂O₃) has a lower hardness than silicon (Si), no flaws normally occur on the semiconductor wafer (silicon wafer). However, if the protrusion 132 is provided, flaws occur on the semiconductor wafer (silicon wafer) even if the protrusion 132 is an yttria (Y₂O₃) polycrystalline structure as shown in FIG. 17. It is considered that this is because the tip of the corner 132c is entangled during sliding between the semiconductor wafer (silicon wafer) and the flat surface 132b.

In contrast, as shown in FIG. 15, the protrusion 32 according to this embodiment has a flat surface 32b on top, which is connected to its side face through the intermediary of an outwardly convex curved surface 32c. That is, a curved surface 32c is provided at the periphery of the top (flat surface 32b) of the protrusion 32.

Hence, even if sliding occurs between the flat surface 32b and the semiconductor wafer (silicon wafer), the curved surface 32c serves to prevent the periphery of the flat surface 32b from being entangled. Consequently, occurrence of flaws on the semiconductor wafer (silicon wafer) can be prevented, and particle contamination can be also prevented.

In this curved surface working, use of aerosol deposition capable of forming a dense polycrystalline structure in combination with use of yttria (Y₂O₃) slightly softer than alumina facilitates finishing curved surfaces in a fine and less defective condition.

In this case, the curvature radius R of the curved surface 32c is preferably 5 μm or more and 1000 μm or less.

Typically, the surface roughness of the rear surface of a semiconductor wafer (silicon wafer) is approximately 0.1 to 0.2 μm in terms of Ra (center-line average roughness) and approximately 0.6 to 0.7 μm in terms of Rz (ten-point average height roughness). Hence, if the curvature radius of the curved surface 32c is 5 μm or more, it is possible to prevent the protrusion on the semiconductor wafer (silicon wafer) rear surface from being entangled by contact with the periphery of the flat surface 32b.

Furthermore, in the case where the curved surfaces 32c are formed, for example, by buff polishing described later, if the curvature radius R exceeds 1000 μm, the protrusion 32 itself is also unfortunately polished, being likely to cause configurational problems. Hence the curvature radius R is preferably 1000 μm or less in view of working.

As shown in FIGS. 15 and 16, the surface roughness of the bottom of the recess 32a is greater than the surface roughness of the flat surface 32b. For example, the surface roughness of the flat surface 32b is approximately 0.009 μm in terms of Ra (center-line average roughness), whereas the surface roughness of the bottom of the recess 32a is approximately 0.33 μm in terms of Ra (center-line average roughness).

The height h1 of the protrusion 32 is generally equal to the thickness h2 of the polycrystalline structure 7. For example, the height h1 of the protrusion 32 and the thickness h2 of the polycrystalline structure 7 are approximately 10 μm. It is noted that the height h1 of the protrusion 32 is preferably in the range of 5 to 30 μm in view of suction force and reduction of particle attachment.

According to this embodiment, because the flat surface 32b has a very smooth surface, adhesion to the workpiece can be enhanced, and occurrence of flaws can be prevented.

Furthermore, the bottom of the recess 32a is roughened so as to enlarge its surface area. Hence the efficiency of heat exchange with helium gas introduced into the recess 32a can be enhanced, and the temperature controllability and in-plane temperature uniformity of the workpiece can be improved.

Next, a method for manufacturing the electrostatic chuck 30 is described.

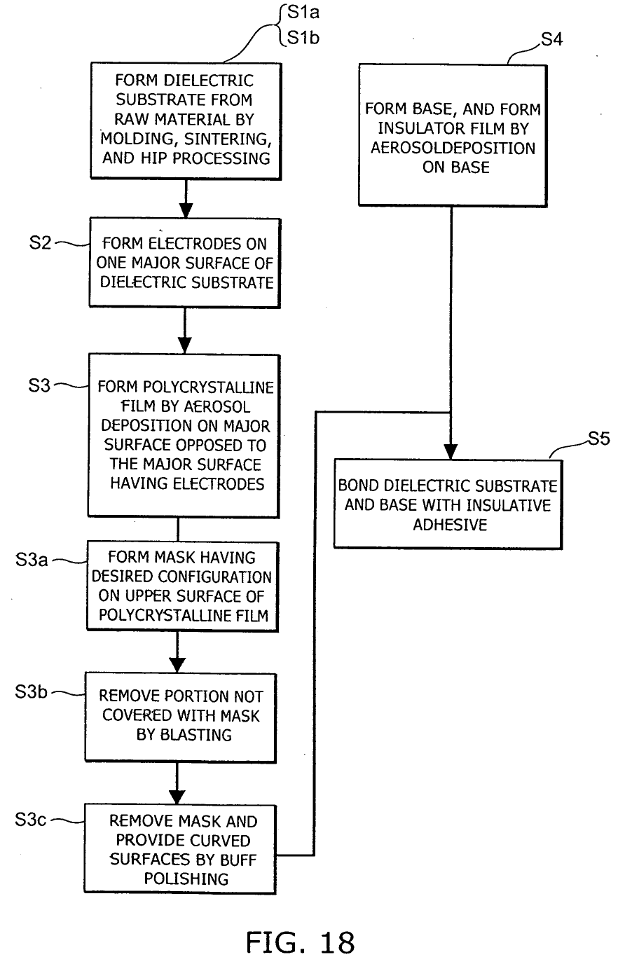

FIG. 18 is a flow chart for illustrating the method for manufacturing the electrostatic chuck 30.

It is different from that described with reference to FIG. 2 in that protrusions 32 are further formed. Hence, because the steps other than formation of the protrusions 32 are the same as those in FIG. 2, they are marked with like step numbers, and the description thereof is omitted.

The upper surface of the polycrystalline structure 7 formed as in step S3 of FIG. 2 is polished, and a resist film is applied to the surface thereof and exposed to form a mask having a desired configuration (step S3a).

For example, a mask with features spaced at a predetermined pitch and having a diameter of approximately 250, 500, 1000, and 2000 μm is formed.

Next, blasting is performed from above the mask to remove the portion of the upper surface of the polycrystalline structure 7 not covered with the mask (step S3b).

Here, for example, the polycrystalline structure 7 can be removed approximately 10 μm from its upper surface. In this case, for example, wet etching can be also used for the removal. However, if blasting is used for the removal, the dimensional accuracy of the height of the protrusion 32 can be enhanced, and hence variation in the developed electrostatic force can be reduced. Furthermore, the bottom of the recess 32a can be roughened. Hence, as described above, the efficiency of heat exchange with helium gas can be enhanced, and the temperature controllability and in-plane temperature uniformity of the workpiece can be improved.

Next, the mask is removed, and the surface is buff-polished to provide a curved surface 32c on the protrusion 32 and to smoothly finish a flat surface 32b (step S3c).

As a result of the foregoing, for example, the diameter of the protrusion 32 can be approximately 250 to 2000 μm, the surface roughness of the flat surface 32b can be approximately 0.009 μm in terms of Ra (center-line average roughness) and approximately 0.08 μm in terms of Rz (ten-point average height roughness), the curvature radius R of the curved surface 32c can be approximately 122 to 182 μm, and the surface roughness of the bottom of the recess 32a can be approximately 0.33 μm in terms of Ra (center-line average roughness) and approximately 2.36 μm in terms of Rz (ten-point average height roughness).

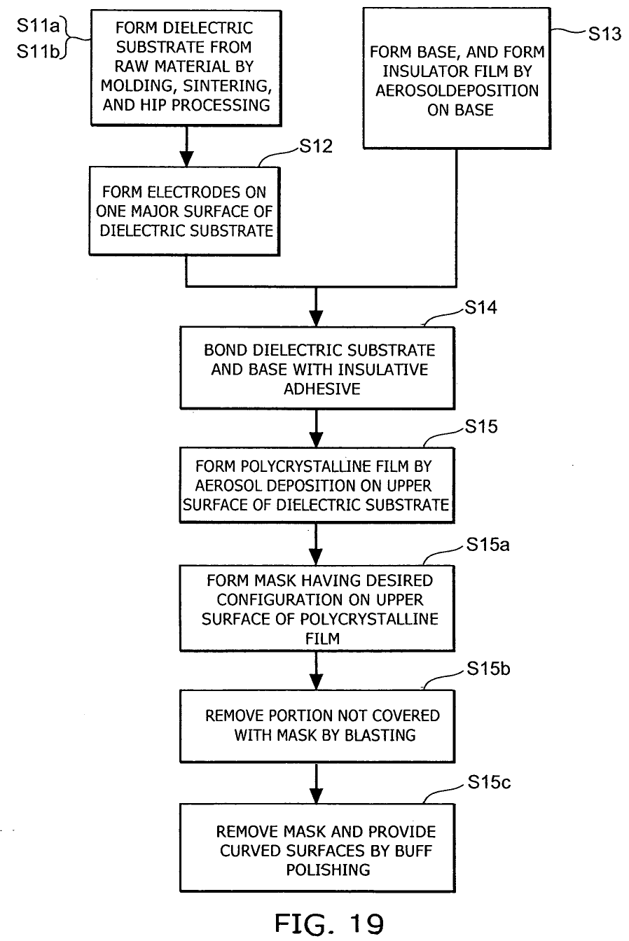

FIG. 19 is a flow chart for illustrating another example method for manufacturing the electrostatic chuck 30.

It is different from that described with reference to FIG. 3 in that protrusions 32 are further formed. Hence, because the steps other than formation of the protrusions 32 are the same as those in FIG. 3, they are marked with like step numbers, and the description thereof is omitted.

Formation of the protrusions 32 is the same as that described with reference to FIG. 18. However, in contrast to FIG. 18, the procedure of forming the polycrystalline structure 7 is different. That is, after the base 2 and the dielectric substrate 3 are bonded together, a polycrystalline structure 7 is formed by aerosol deposition on the upper surface of the dielectric substrate 3 (the major surface opposed to the major surface with the electrodes provided thereon). Subsequently, protrusions 32 are formed.

Specifically, as in step S11a, S11b, step S12, step S13, step S14, and step S15 of FIG. 3, the base 2 and the dielectric substrate 3 are bonded together, and a polycrystalline structure 7 is formed by aerosol deposition on the major surface of the dielectric substrate 3 opposed to the major surface with the electrodes 4 provided thereon.

Subsequently, as in step S3a of FIG. 18, the upper surface of the polycrystalline structure 7 is polished, and a resist film is applied to the surface thereof and exposed to form a mask having a desired configuration (step S15a).

Next, as in step S3b of FIG. 18, blasting is performed from above the mask to remove the portion of the upper surface of the polycrystalline structure 7 not covered with the mask (step S15b).

Next, as in step S3c of FIG. 18, the mask is removed, and the surface is buff-polished to provide a curved surface 32c on the protrusion 32 and to smoothly finish a flat surface 32b (step S15c).

In this embodiment, after the base 2 and the dielectric substrate 3 are bonded together, a polycrystalline structure 7 is formed by aerosol deposition on the upper surface of the dielectric substrate 3 (the major surface opposed to the major surface with the electrodes provided thereon).

Thus the stiffness of the matrix (bonded body of the base 2 and the dielectric substrate 3) used for film formation can be increased. Hence, as described with reference to FIG. 3, deformation due to the residual stress can be prevented. Consequently, the flatness of the flat surface 32b (mounting surface) of the protrusion 32 can be further increased, and adhesion to the workpiece can be further improved.

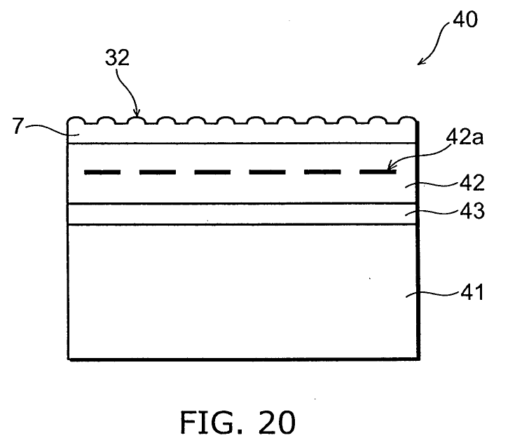

FIGS. 20 to 24 are schematic views for illustrating the configuration of electrostatic chucks.

To avoid complicating the drawings, the base 2, the insulator film 5, and the channel 8 below the electrostatic chuck are not shown and are collectively referred to as a temperature control member. The description thereof is also omitted. The wires 9 are also not shown.

The electrostatic chuck 40 illustrated in FIG. 20 comprises a temperature control member 41 and an electrode section 42, which is a member including electrodes 42a. The electrode section 42 is provided on one major surface of the temperature control member 41 via a bonding layer 43. A polycrystalline structure 7 and protrusions 32 are provided on the major surface of the electrode section 42.

The electrode section 42 is made of a burned material (e.g., sintered ceramic) and has a plurality of electrodes 42a inside. The bonding layer 43 is a cured insulative adhesive like the bonding layer 6 described above. Alternatively, the bonding layer 43 can be formed by glass bonding.

With regard to a method for manufacturing the electrostatic chuck 40, as in FIG. 18, the polycrystalline structure 7 and the protrusions 32 can be formed on the major surface of the electrode section 42, and then bonded to the temperature control member 41 via a bonding layer 43. Alternatively, as in FIG. 19, the electrode section 42 and the temperature control member 41 can be bonded together via a bonding layer 43, and then, in the same manner as described above, the polycrystalline structure 7 and the protrusions 32 can be formed on the major surface of the electrode section 42.

Here, known techniques are applicable to the manufacturing of the electrode section 42 including electrodes 42a and made of a burned material. Hence the description of the manufacturing method therefor is omitted.

In this case, if the polycrystalline structure 7 and the protrusions 32 are finally formed as in FIG. 19, the stiffness of the matrix (bonded body of the electrode section 42 and the temperature control member 41) used for film formation can be increased. Hence deformation due to the residual stress can be prevented. Consequently, the flatness of the flat surface 32b (mounting surface) of the protrusion 32 can be further increased, and adhesion to the workpiece can be further improved.

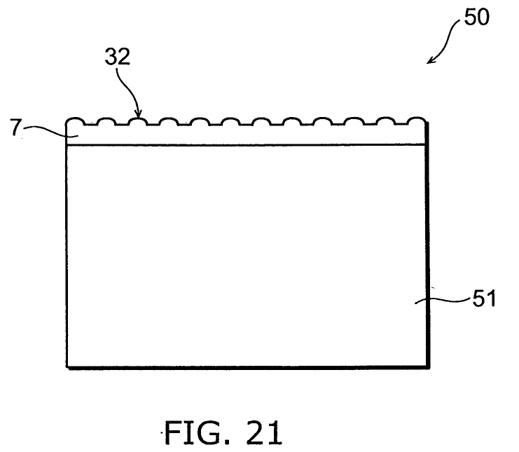

The electrostatic chuck 50 illustrated in FIG. 21 comprises a temperature control member 51. A polycrystalline structure 7 and protrusions 32 are provided on one major surface of the temperature control member 51.

The temperature control member 51 in this embodiment comprises a base 2 and a channel 8 provided inside the base 2, which are not shown. The polycrystalline structure 7 is provided directly on the major surface of the base 2, not shown, and the base 2 also serves as an electrode. Hence, in this embodiment, the temperature control member 51 is the member with the electrode provided thereon. That is, the electrostatic chuck 50 is a monopolar electrostatic chuck.

With regard to a method for manufacturing the electrostatic chuck 50, as in FIG. 19, the polycrystalline structure 7 and the protrusions 32 are formed on the major surface of the temperature control member 51 (base 2, not shown).

Thus the stiffness of the matrix (temperature control member 51) used for film formation can be increased. Hence deformation due to the residual stress can be prevented. Consequently, the flatness of the flat surface 32b (mounting surface) of the protrusion 32 can be further increased, and adhesion to the workpiece can be further improved.

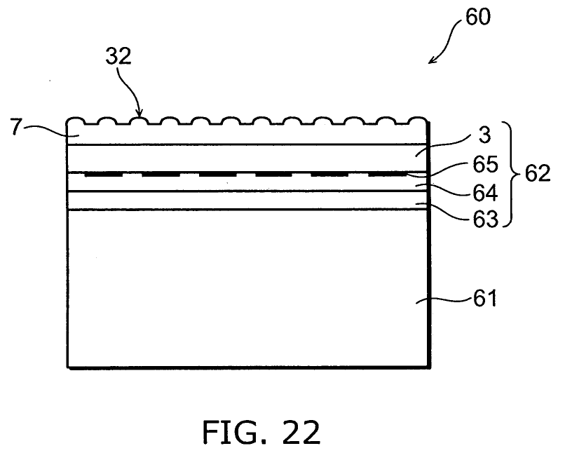

The electrostatic chuck 60 illustrated in FIG. 22 comprises a temperature control member 61 and an electrode section 62, which is a member including electrodes 65. The electrode section 62 is provided on one major surface of the temperature control member 61 via a bonding layer 63. A polycrystalline structure 7 and protrusions 32 are provided on the major surface of the electrode section 62.

The electrode section 62 comprises a dielectric substrate 3, a plurality of electrodes 65 provided on one major surface of the dielectric substrate 3, and an insulator film 64 covering the electrodes 65.

The insulator film 64 can be the same as the insulator film 5 described above.

The bonding layer 63 is a cured insulative adhesive like the bonding layer 6 described above. Alternatively, the bonding layer 63 can be formed by glass bonding.

With regard to a method for manufacturing the electrostatic chuck 60, as in FIG. 18, the polycrystalline structure 7 and the protrusions 32 can be formed on the major surface of the electrode section 62, and then bonded to the temperature control member 61 via a bonding layer 63. Alternatively, as in FIG. 19, the electrode section 62 and the temperature control member 61 can be bonded together via a bonding layer 63, and then, in the same manner as described above, the polycrystalline structure 7 and the protrusions 32 can be formed on the major surface of the electrode section 62.

In this case, if the polycrystalline structure 7 and the protrusions 32 are finally formed as in FIG. 19, the stiffness of the matrix (bonded body of the electrode section 62 and the temperature control member 61) used for film formation can be increased. Hence deformation due to the residual stress can be prevented. Consequently, the flatness of the flat surface 32b (mounting surface) of the protrusion 32 can be further increased, and adhesion to the workpiece can be further improved.

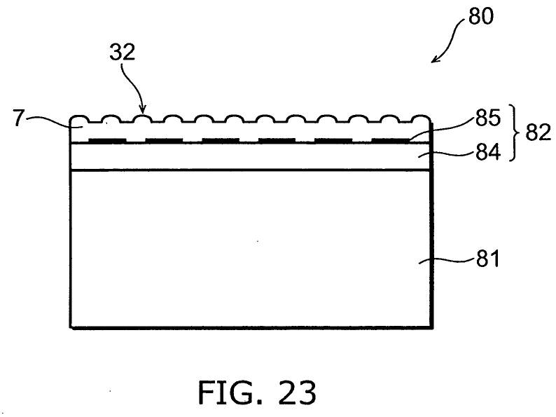

The electrostatic chuck 80 illustrated in FIG. 23 comprises a temperature control member 81 and an electrode section 82, which is a member including electrodes 85. The electrode section 82 is provided on one major surface of the temperature control member 81. A polycrystalline structure 7 and protrusions 32 are provided on the major surface of the electrode section 82.

The electrode section 82 comprises a polycrystalline structure 84 and a plurality of electrodes 85 provided on one major surface of the polycrystalline structure 84.

The polycrystalline structure 84 can be the same as the insulator film 5 described above.

With regard to a method for manufacturing the electrostatic chuck 80, first, a polycrystalline structure 84 is formed on the major surface of the temperature control member 81 (base 2, not shown). The polycrystalline structure 84 can be composed of polycrystals of alumina (Al₂O₃) or yttria (Y₂O₃), for example. Furthermore, the polycrystalline structure 84 can be formed by aerosol deposition.

Next, a conductive film is formed on the major surface of the polycrystalline structure 84. The conductive film can be formed by CVD (chemical vapor deposition) or PVD (physical vapor deposition).

Next, the formed film is shaped into a predetermined configuration by sand blasting or etching to form electrodes 85 having a desired configuration.

Next, in the same manner as described above, a polycrystalline structure 7 is formed on the major surface of the polycrystalline structure 84 so as to cover the electrodes 85.

Next, the surface is polished, and protrusions 32 are formed by blasting. Then curved surfaces are formed by buff polishing.

In this case, if the polycrystalline structure 7 and the protrusions 32 are finally formed as in FIG. 19, the stiffness of the matrix (temperature control member 81) used for film formation can be increased. Hence deformation due to the residual stress can be prevented. Consequently, the flatness of the flat surface 32b (mounting surface) of the protrusion 32 can be further increased, and adhesion to the workpiece can be further improved.

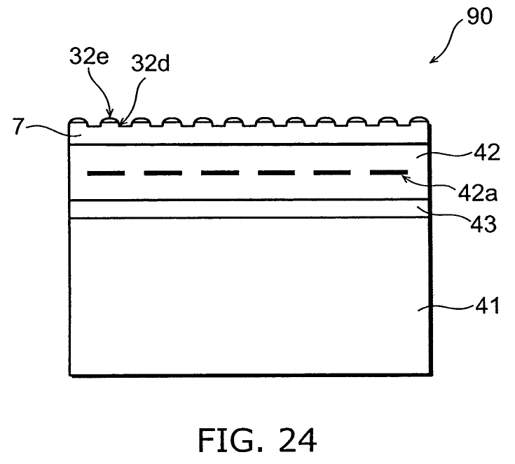

The electrostatic chuck 90 illustrated in FIG. 24 comprises a temperature control member 41 and an electrode section 42, which is a member including electrodes 42a. The electrode section 42 is provided on one major surface of the temperature control member 41 via a bonding layer 43. The polycrystalline structure 7, protrusions 32d, and protrusion surface layers 32e are provided on the major surface of the electrode section 42.

The electrode section 42 is made of a burned material (e.g., sintered ceramic) and has a plurality of electrodes 42a inside. The bonding layer 43 is a cured insulative adhesive like the bonding layer 6 described above. Alternatively, the bonding layer 43 can be formed by glass bonding.

With regard to a method for manufacturing the electrostatic chuck 90, as in FIG. 18, the polycrystalline structure 7, the protrusions 32d, and the protrusion surface layers 32e can be formed on the major surface of the electrode section 42, and then bonded to the temperature control member 41 via a bonding layer 43. Alternatively, as in FIG. 19, the electrode section 42 and the temperature control member 41 can be bonded together via a bonding layer 43, and then, in the same manner as described above, the polycrystalline structure 7, the protrusions 32d, and the protrusion surface layers 32e can be formed on the major surface of the electrode section 42.

Here, known techniques are applicable to the manufacturing of the electrode section 42 including electrodes 42a and made of a burned material. Hence the description of the manufacturing method therefor is omitted.

The protrusions 32d can be composed of polycrystals of alumina (Al₂O₃) or yttria (Y₂O₃), for example. Furthermore, the protrusions 32d can be formed by aerosol deposition.

The protrusion surface layers 32e can be composed of polycrystals of yttria (Y₂O₃). Furthermore, the protrusion surface layers 32e can be formed by aerosol deposition.

Here, a film to constitute the protrusions 32d is formed, and on the surface thereof, a film to constitute the protrusion surface layers 32e is formed. Then, in the same manner as described above, the protrusions 32d and the protrusion surface layers 32e can be formed by blasting, and curved surfaces can be formed by buff polishing.

Alternatively, after the protrusions 32d are formed by blasting, the protrusion surface layers 32e can be selectively formed on top of the protrusions 32d, and curved surfaces can be formed by buff polishing.

In this case, if the polycrystalline structure 7, the protrusions 32d, and the protrusion surface layers 32e are finally formed as in FIG. 19, the stiffness of the matrix (bonded body of the electrode section 42 and the temperature control member 41) used for film formation can be increased. Hence deformation due to the residual stress can be prevented. Consequently, the flatness of the upper surface (flat surface (mounting surface)) of the protrusion surface layer 32e can be further increased, and adhesion to the workpiece can be further improved.

It is noted that in the electrostatic chuck, the configuration of the elements located below the polycrystalline structure 7 is not limited to those described above, but can be variously modified.

The major surface of the member including the electrodes opposed to the major surface with the polycrystalline structure 7 formed thereon can be bonded to one major surface of the base after any of the above-described steps of forming the polycrystalline structure 7, forming the protrusions 32, and forming the curved surfaces 32c.

It is possible to form the polycrystalline structure 7 and the protrusions 32 after forming the elements located below the polycrystalline structure 7 (after forming the elements to serve as a matrix in advance). Then deformation due to the residual stress can be prevented. Consequently, the flatness of the flat surface 32b (mounting surface) of the protrusion 32 can be further increased, and adhesion to the workpiece can be further improved.

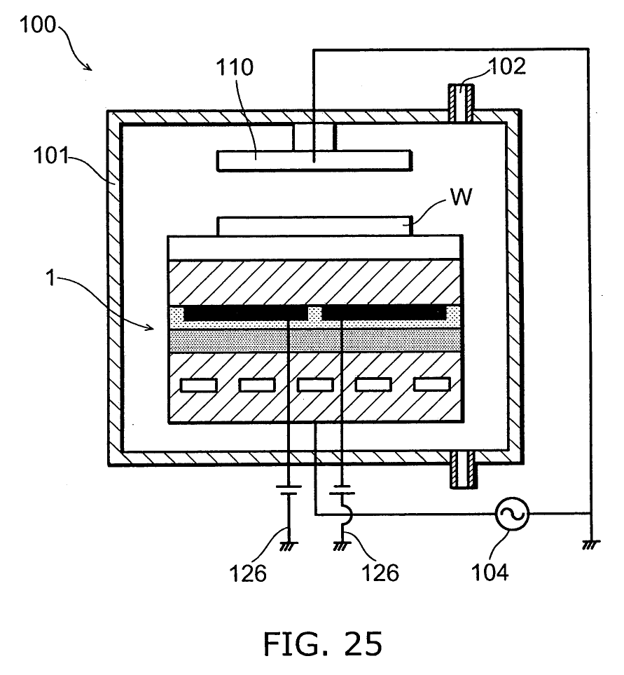

FIG. 25 is a schematic view for illustrating a substrate processing apparatus including the electrostatic chuck according to the embodiment of the invention.

The substrate processing apparatus 100 comprises a processing chamber 101, an upper electrode 110, and the electrostatic chuck 1 according to the invention. On the ceiling of the processing chamber 101 is provided a processing gas introduction port 102 for introducing a processing gas therein. In the bottom plate of the processing chamber 101 is provided an evacuation port 103 for decompressing and evacuating the inside thereof. A radio-frequency power supply 104 is connected to the upper electrode 110 and the electrostatic chuck 1 so that a pair of electrodes, composed of the upper electrode 110 and the electrostatic chuck 1, are opposed in parallel to each other across a predetermined spacing. In the substrate processing apparatus 100 thus configured, application of a radio-frequency voltage between the upper electrode 110 and the electrostatic chuck 1 causes radio-frequency discharge, and the processing gas introduced into the processing chamber 101 is excited and activated by plasma, thereby processing a workpiece W. Here, the workpiece W can illustratively be a semiconductor substrate (wafer), but is not limited thereto. For example, it may be a glass substrate for use in a liquid crystal display device.

The apparatus configured like the substrate processing apparatus 100 is generally referred to as a parallel plate RIE (reactive ion etching) apparatus. However, the electrostatic chuck according to the invention is not limited to application to this apparatus. For example, the invention is widely applicable to the so-called reduced-pressure processing apparatuses such as an ECR (electron cyclotron resonance) etching apparatus, an inductively coupled plasma processing apparatus, a helicon-wave plasma processing apparatus, a plasma-isolated plasma processing apparatus, a surface-wave plasma processing apparatus, and a plasma CVD (chemical vapor deposition) apparatus, and also widely applicable to substrate processing apparatuses such as an exposure apparatus and an inspection apparatus used for processing and inspection under atmospheric pressure. However, the invention is preferably applied to a plasma processing apparatus in view of high plasma resistance of the electrostatic chuck according to the invention. In the configuration of these apparatuses, known configurations are applicable to the elements other than the electrostatic chuck according to the invention, and hence the description thereof is omitted.

Furthermore, the electrostatic chuck is not limited to the electrostatic chuck 1 described with reference to FIG. 1, but it is also possible to use, for example, the electrostatic chuck 30 described with reference to FIG. 11, the electrostatic chuck 40 described with reference to FIG. 20, the electrostatic chuck 50 described with reference to FIG. 21, and the electrostatic chuck 60 described with reference to FIG. 22.

The embodiment of the invention has been described with reference to the examples. However, the invention is not limited to these examples.

The above examples can be modified appropriately by those skilled in the art, and such modifications are also encompassed within the scope of the invention as long as they include the features of the invention.

For example, for convenience of description, reference is made to the Coulomb type electrostatic chuck and the Johnsen-Rahbek type electrostatic chuck. However, it is also possible to use an electrostatic chuck based on the gradient force, where a nonuniform electric field is formed above the suction surface to partially polarize a workpiece, which is an insulator, accompanied by a force of attraction (gradient force) toward higher electric field strength.

The shape, dimension, material, constituent ratio, and placement of the elements included in the electrostatic chuck and the substrate processing apparatus are not limited to those illustrated above, but can be modified appropriately, and such modifications are also encompassed within the scope of the invention as long as they include the features of the invention.

The elements included in the above examples can be combined with each other as long as feasible, and such combinations are also encompassed within the scope of the invention as long as they include the features of the invention.

1. An electrostatic chuck comprising:
a mounting surface on which a workpiece is to be mounted, the mounting surface including a polycrystalline structure formed by aerosol deposition, the polycrystalline structure having a protrusion on its surface,
at least the protrusion containing yttria (Y₂O₃).

2. An electrostatic chuck comprising:
a polycrystalline structure on a major surface of a member including an electrode, the polycrystalline structure being formed by aerosol deposition,
the polycrystalline structure having a protrusion on its surface, and
at least the protrusion containing yttria (Y₂O₃).

3. An electrostatic chuck comprising:
a mounting surface on which a workpiece is to be mounted, the mounting surface including a polycrystalline structure made of a brittle material, the polycrystalline structure having a protrusion on its surface,
at least the protrusion containing yttria (Y₂O₃), and substantially no grain boundary layer of a glass phase existing at a crystal-crystal interface.

4. An electrostatic chuck comprising:
a polycrystalline structure on a major surface of a member including an electrode, the polycrystalline structure being made of a brittle material,
the polycrystalline structure having a protrusion on its surface, and
at least the protrusion contains yttria (Y₂O₃), and substantially no grain boundary layer of a glass phase existing at a crystal-crystal interface.

5. The electrostatic chuck according to claim 1, wherein a curved surface is provided on a periphery of top of the protrusion.

6. The electrostatic chuck according to claim 1, further comprising:
a flat surface provided on top of the protrusion; and
a recess formed by the protrusion provided on the surface of the polycrystalline structure,
bottom of the recess having a greater surface roughness than the flat surface.

7. The electrostatic chuck according to claim 5, wherein the curved surface is formed by buff polishing.

8. The electrostatic chuck according to claim 1, further comprising:
a base with an insulator film formed on at least one major surface thereof; and
a bonding layer provided between a major surface of a member including an electrode opposed to the major surface with the polycrystalline structure formed thereon and the major surface of the base with the insulator film formed thereon,
the insulator film being a polycrystal made of a brittle material.

9. The electrostatic chuck according to claim 8, wherein the insulator film is formed by thermal spraying.

10. The electrostatic chuck according to claim 8, wherein substantially no grain boundary layer of a glass phase exists in the insulator film.

11. The electrostatic chuck according to claim 10, wherein the insulator film is formed by aerosol deposition.

12. The electrostatic chuck according to claim 8, wherein the base includes a channel for fluid.

13. The electrostatic chuck according to claim 8, wherein the insulator film contains yttria (Y₂O₃).

14. The electrostatic chuck according to claim 1, wherein the polycrystalline structure contains yttria (Y₂O₃).

15. The electrostatic chuck according to claim 1, wherein a member including an electrode is made of a sintered ceramic having an average particle size of 2 μm or less.

16. The electrostatic chuck according to claim 15, wherein the electrode is located on a major surface of the member opposed to the major surface with the polycrystalline structure formed thereon.

17. A method for manufacturing an electrostatic chuck, comprising:
forming a polycrystalline structure by aerosol deposition on one major surface of a member including an electrode; and
forming a protrusion by providing a mask having a desired configuration on a surface of the polycrystalline structure and removing a portion not covered with the mask by blasting.

18. The method for manufacturing an electrostatic chuck according to claim 17, further comprising:
forming a curved surface on a periphery of top of the protrusion by buff polishing.

19. The method for manufacturing an electrostatic chuck according to claim 17, wherein the polycrystalline structure is formed after the member is bonded to one major surface of a base.

20. The method for manufacturing an electrostatic chuck according to claim 17, wherein a major surface of the member opposed to the major surface with the polycrystalline structure formed thereon is bonded to one major surface of a base after any one step selected from the group consisting of the step of forming the polycrystalline structure, the step of forming the protrusion, and the step of forming a curved surface.

21. The method for manufacturing an electrostatic chuck according to claim 17, further comprising:
forming a channel in a base.

22. A substrate processing apparatus comprising:
the electrostatic chuck according to claim 1.
